(19) United States
(12) Patent Application Publication
(10) Pub. No.: US 2006/0183071 A1
(43) Pub. Date: Aug. 17, 2006

(54) Phototherapeutic toothbrush

(76) Inventor: Pei-Hsien Hsuch, Yung-Ho City (TW)

Correspondence Address: RABIN & BERDO, P.C., Suite 500, 1101 14th Street, N.W., Washington, DC, 20005, US

(21) Appl. No.: 11/055,607

(22) Filed: Feb. 11, 2005

(51) Int. Cl. A61C 3/00

(52) U.S. Cl. 433/29; 433/215

(57) ABSTRACT

A phototherapeutic toothbrush comprises a handle, a circuit board and a brush jacket. The handle can accommodate the circuit board, which is fitted with an extension board extending outside of the handle. The extension board is equipped with at least one light source. When brush jacket with a brush head is linked to the handle, the light source can duly generate phototherapeutic and bactericidal light to irradiate and cure the mouth surfaces and sterilize the bristle of brush head.

### BACKGROUND OF THE INVENTION

1. Field of the Invention

The present invention relates generally to a phototherapeutic toothbrush, and more particularly to a phototherapeutic toothbrush having light sources at brush jacket that allow penetrating phototherapeutic and bactericidal rays for mouth cavity and bristle of brush head.

2. Description of the Related Art

As described in TWN Patent Publication No. 545,218 “Electric Toothbrush Structure”, the typical electric toothbrush comprises a brush body, a rotating block, an actuating rod, a spring and a detachable brush head. The brush body is fitted with a motor and some batteries, while a shaft is mounted onto the motor. A rotating block with an upwardly inclined plane is securely fixed at top of the shaft. The bottom of actuating rod is connected to upwardly inclined plane of the rotating block whereas a bumping post is placed at the side of actuating rod. The spring is compressed and fixed between an upper outlet of brush body and bumping post. Fitted with bristle, the detachable brush head can be connected with actuating rod. When the motor is powered by battery, the detachable brush head is driven through rotating block and actuating rod for cleaning teeth.

Despite of the fact that above-specified electric toothbrush may reduce the possibility of oral diseases arising from higher vibration frequency of typical electric toothbrush, the following problems occur at practical application of this electric toothbrush: for the patients of ordinary oral diseases, such as, ulcer, gum exanthema, gum pain and halitosis, etc, no electric toothbrush is acceptable. If electric toothbrush is applied, it will surely worsen the diseases, or even lead to further laceration of the mouth wound. Moreover, dirt and bacteria are easy to be accumulated at bristle of detachable brush head over a long-term use. If sterilization work cannot be performed frequently, it is likely to increase the replacement cost of brush head. Therefore, it is very necessary to modify the above-specified electric toothbrush.

To overcome the aforementioned problems of the prior art, several light sources shall be placed at both sides of brush jacket of phototherapeutic toothbrush. During operation of phototherapeutic toothbrush, the light source can generate phototherapeutic and bactericidal red light or infrared ray for light therapy and sterilization of mouth surface and bristle of brush head. Thus, the present invention can virtually offer an enhanced light therapy and sterilization effect and further improve the added value of toothbrush.

### SUMMARY OF THE INVENTION

The primary objective of the present invention is to provide a phototherapeutic toothbrush, which is provided with several light sources at one brush jacket to generate phototherapeutic red light or infrared ray for the mouth surface. In this way, it is possible to enhance the light therapy and sterilization effect and further improve the added value of toothbrush.

The secondary objective of the present invention is to provide a phototherapeutic toothbrush, which is provided with several light sources at one brush jacket to generate phototherapeutic red light or infrared ray for the bristle of brush head. In this way, the present invention may offer an enhanced light therapy and sterilization effect as well as an improved value-added toothbrush.

The phototherapeutic toothbrush of the present invention comprises a handle, a circuit board and a brush jacket. The handle can accommodate the circuit board, which is fitted with an extension board extended outside of the handle. The extension board is equipped with at least one first light source while the brush jacket is fitted with a brush head. When the brush jacket is connected to the handle, the light source can duly generate phototherapeutic and bactericidal rays for sterilization of mouth surface and bristle of brush head.

### BRIEF DESCRIPTION OF THE DRAWINGS

FIG. 1 shows a decomposed perspective view of the present invention.

FIG. 2 shows a cutaway view of the present invention.

FIG. 3 shows the control block of the present invention.

FIG. 4 shows the application diagram of the present invention.

FIG. 5 shows a decomposed perspective view of the second embodiment of the present invention.

FIG. 6 shows a decomposed perspective view of the third embodiment of the present invention.

### DETAILED DESCRIPTION OF THE INVENTION

The features and the advantages of the present invention will be more readily understood upon a thoughtful deliberation of the following detailed description of a preferred embodiment of the present invention with reference to the accompanying drawings.

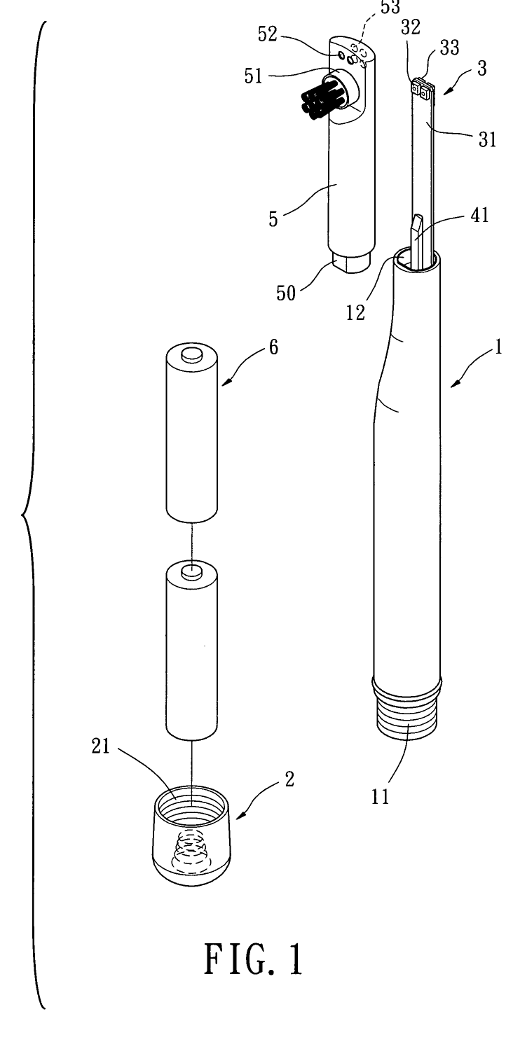

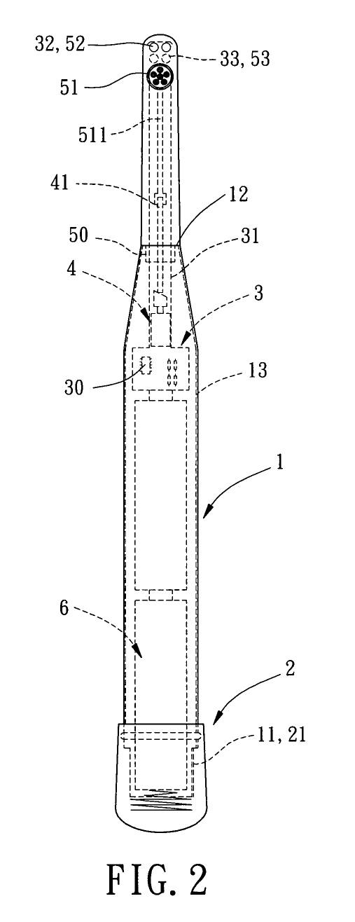

As shown in FIGS. 1-2, a phototherapeutic toothbrush embodied in the present invention comprises:

a handle 1, a cover 2, a circuit board 3, a driver 4 and a brush jacket 5. The handle 1 is fitted with a lower connector 11, an upper connector 12 and a compartment 13 while cover 2 is also provided with a connector 21. The lower connector 11 of handle 1 can be screw-connected to connector 21 of the cover 2, such that several batteries 6 can be accommodated into compartment 13 of the handle 1. Meanwhile, through adjusting the screwing degree of cover 2, positive and negative electric terminals (not labeled) of cover 2 and handle 1 can selectively connect or disconnect for switching on or off. Thus, cover 2 is also considered as the switch of battery 6.

As shown in FIGS. 1 and 2, in the first embodiment, circuit board 3 is equipped with a control circuit 30, an extension board 31, several first light sources 32 and second light sources 33. The circuit board 3 is essentially positioned within compartment 13 of handle 1, the control circuit 30 is printed onto the circuit board 3, while extension board 31 extends outside of upper connector 12. The first light source 32 is mounted at frontal surface of extension board 31, and second light source 33 at back surface of extension board 31. Preferably, two or three first light sources 32 and four second light sources 33 are provided.

Moreover, the above-specified first light source 32 and second light source 33 are selected from phototherapeutic and bactericidal light sources, such as red light or infrared ray, and more particularly to those with a frequency range from 600 nm to 1000 nm, or preferred visible lights ranging from 630 nm to 660 nm. The aforementioned red light or infrared ray can offer a desirable sterilization effect while facilitating the wound healing, generation of growth factors, collagen and extracellular matrix as well as proliferation of fibroblast. Additionally, The aforementioned red light or infrared ray can function well in the form of narrow-band LED (single-frequency LED), thus featuring lightweight, long service life, fault tolerance, low power consumption and stability of light sources.

As shown in FIGS. 1 and 2, in the first embodiment of present invention, a driver 4 provides with an optional drive mechanism. For example, a motor and a rotating block are preferred options for driver 4, and the dynamics is sourced from an actuating rod 41. Besides, the brush jacket 5 is constructed of transparent materials, and fitted with a connector 50, a brush head 51, several frontal light transparency 52 and rear light transparency 53. The brush jacket 5 is fittingly linked to upper connector 12 of handle 1 via connector 50. And, the brush head 51 can be incorporated into frontal surface of brush jacket 5 for rotational movement or vibration. The inner side of brush head 51 is connected to an interlocking rod 511, which allows for insertion of actuating rod 41 of driver 4, such that the brush head 51 can be driven for rotation and vibration. The frontal light transparency 52 and rear light transparency 53 are separately mounted at front and rear surfaces of brush jacket 5, and separately aligned with first and second light sources 32, 33 on extension board 31 of the circuit board 3.

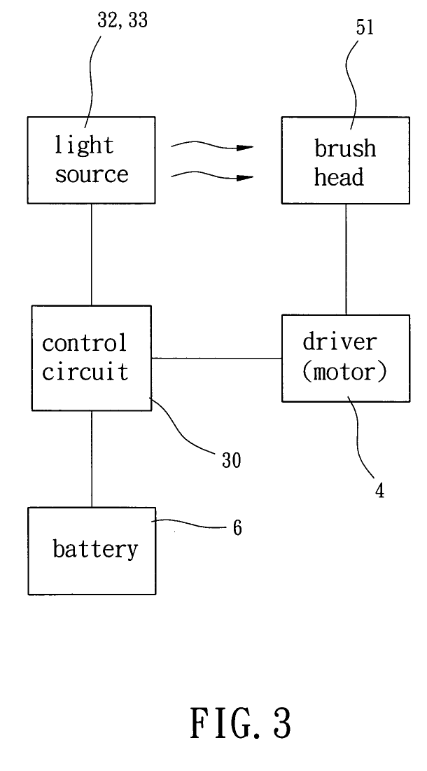

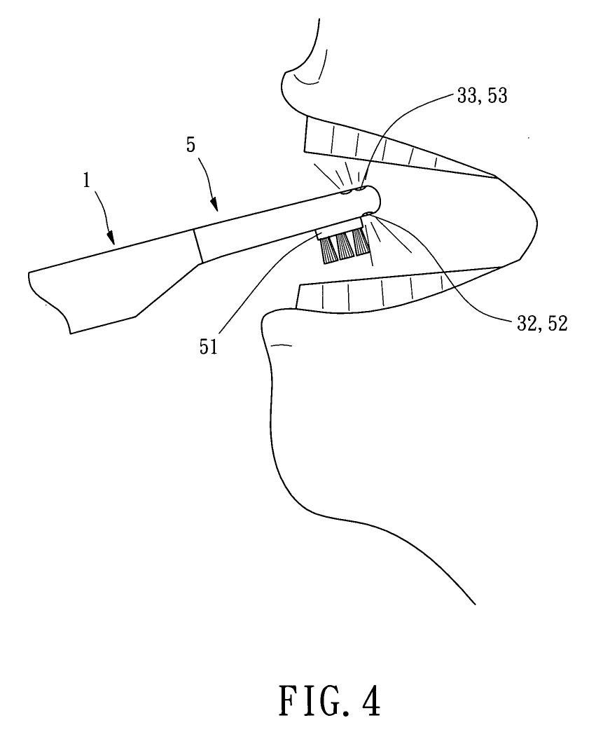

As shown in FIGS. 2, 3 and 4, when first embodiment of present invention—phototherapeutic toothbrush is operated, the user shall hold the handle 1, and switch on the power from activate battery 6, which then powers the control circuit 30 of the circuit board 3. Next, control circuit 30 will adjust electricity and supply power to first light source 32 and second light source 33 as well as driver 4. In such case, the first light source 32 and second light source 33 will be energized to generate phototherapeutic and bactericidal light, such as red light or infrared ray. In the meantime, the driver 4 will activate brush head 51 for rotation and vibration via actuating rod 41 and interlocking rod 511. The first light source 32 is used to irradiate the bristle of brush head 51 and corresponding mouth surface, whereas the second light source 33 is used to irradiate the mouth surface at other parts. Thus, if patients of oral diseases select phototherapeutic toothbrush of the present invention, the above-specified ordinary mouth diseases, such as ulcer, gum exanthema, gum pain and halitosis, can be improved accordingly. On the other hand, as bristle of brush head 51 is often irradiated by first light source 32, it is likely to reduce the replacement frequency and cost of brush head 51.

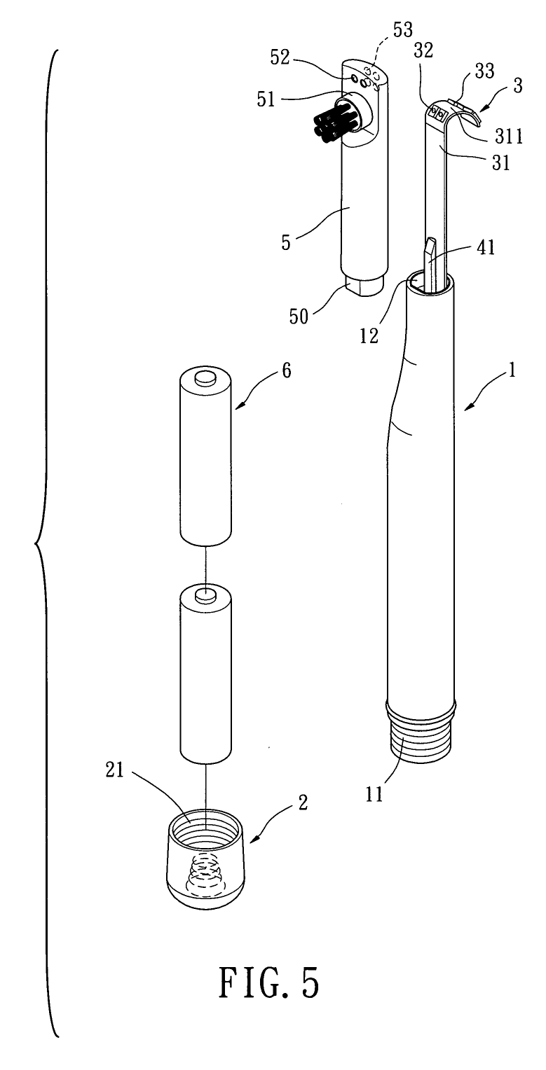

The second embodiment of the present invention—a phototherapeutic toothbrush is shown in FIG. 5. In comparison with the first embodiment, the extension board 31 of circuit board 3 in second embodiment is fitted with a flexible circuit board 311 at the terminal, which is mounted with first and second light sources 32, 33. Alternatively, first light source 32 may be mounted at the extension board 31, and second light source 33 at flexible circuit board 311. So, when the brush jacket 5 is incorporated onto handle 1, the flexible circuit board 311 can be flexibly folded for inserting into the brush jacket 5. As such, the first and second light sources 32, 33 can be properly aligned with frontal light transparency 52 and rear light transparency 53, both of which can generate phototherapeutic and bactericidal light, such as red light or infrared ray.

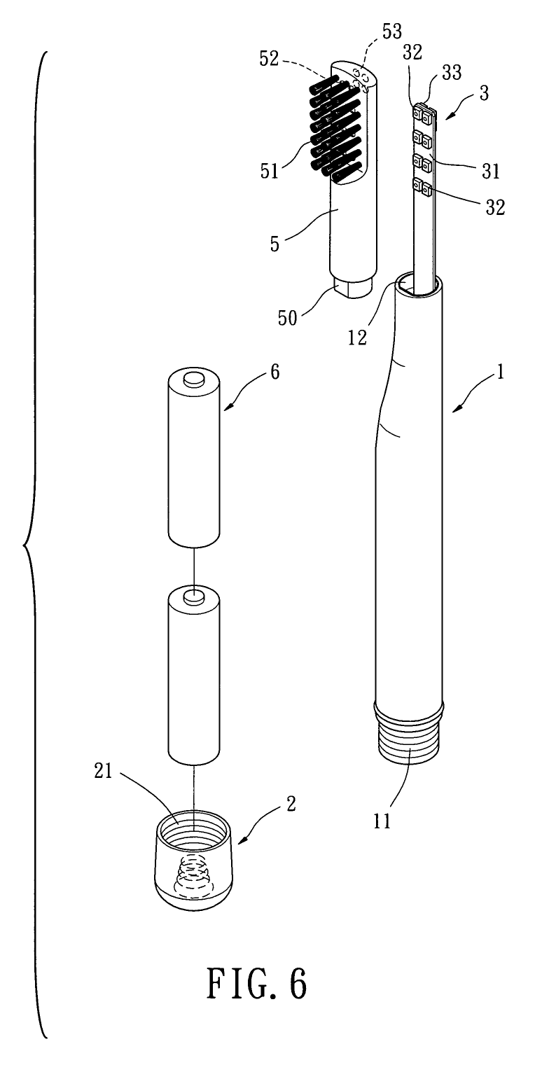

The third embodiment of the present invention—a phototherapeutic toothbrush is shown in FIG. 6. In comparison with the first embodiment, handle 1 omits the driver 4 in the third embodiment. Meanwhile, the bristle of brush head 51 is prefabricated onto frontal surface of brush jacket 5, and the frontal light transparency 52 is aligned between bristle of the brush head 51. In other words, when the present invention is applied to common (manual) toothbrush, the first and second light sources 32, 33 can be properly aligned with the frontal light transparency 52 and rear light transparency 53 in such a manner to offer red light or infrared ray for mouth surface and bristle of brush head 51. More particularly, the first light source 32 can irradiate the bristle of brush head 51 for better sterilization effect.

As mentioned above, conventional electric toothbrush is not suitable for the patients of oral diseases since bacteria is prone to be accumulated at brush head. According to the present invention, the brush jacket 5 is internally fitted with first and second light sources 32, 33, which can generate phototherapeutic and bactericidal light sources, such as red light or infrared ray, to irradiate the mouth surface and bristle of brush head 5 for an enhanced light therapy and sterilization as well as an increased added value of toothbrush.

Though the above are preferred embodiments of present invention, no restriction is placed on the present invention. Thus, it should be appreciated that the present invention is capable of a variety of embodiments and various modifications by those skilled in the art, and all such variations or changes shall be embraced within the scope of the following claims.

What is claimed is:

1. A phototherapeutic toothbrush comprising:
a handle;
a circuit board fixed in the handle, and fitted with an extension board extending outside of the handle, said extension board providing with at least one first light source;
a brush jacket sleeved onto the handle, and received the extension board, said brush jacket providing with a brush head; and
when the phototherapeutic toothbrush is operated, the first light source can generate phototherapeutic and bactericidal light, such that the mouth surface can be irradiated and cured, and bristles of the brush head can be sterilized.

2. A phototherapeutic toothbrush as defined in claim 1, wherein said first light source is mounted at a frontal surface of the extension board of the circuit board.

3. A phototherapeutic toothbrush as defined in claim 1, wherein said brush jacket providing with at least one frontal light transparency, which is aligned with the first light source.

4. A phototherapeutic toothbrush as defined in claim 1, wherein frontal light transparency of said brush jacket is aligned between the bristles of the brush head.

5. A phototherapeutic toothbrush as defined in claim 1, wherein said first light source can be selected from a red light or infrared ray source.

6. A phototherapeutic toothbrush as defined in claim 5, wherein said first light sourcecan be selected from a narrow-band LED generating red light or infrared ray.

7. A phototherapeutic toothbrush as defined in claim 5, wherein said first light source of red light or infrared ray has a frequency ranging from 600 nm to 1000 nm.

8. A phototherapeutic toothbrush as defined in claim 1, wherein the extension board of said circuit board providing with a flexible circuit board at a terminal, which is mounted with the first light source.

9. A phototherapeutic toothbrush as defined in claim 1, wherein the extension board of said circuit board providing with a second light source at a back surface thereof.

10. A phototherapeutic toothbrush as defined in claim 9, wherein said brush jacket providing with at least one rear light transparency, which is aligned with a second light source.

11. A phototherapeutic toothbrush as defined in claim 9, wherein said second light source can be selected from a red light or infrared ray source.

12. A phototherapeutic toothbrush as defined in claim 9, wherein said second light source can be selected from a narrow-band LED generating red light or infrared ray.

13. A phototherapeutic toothbrush as defined in claim 9, wherein said second light source of red light or infrared ray has a frequency ranging from 600 nm to 1000 nm.

14. A phototherapeutic toothbrush as defined in claim 9, wherein the extension board of said circuit board providing with a flexible circuit board at a terminal, which is mounted with the second light source.

15. A phototherapeutic toothbrush as defined in claim 1, wherein said brush jacket is made of transparent materials.

16. A phototherapeutic toothbrush as defined in claim 1, wherein said handle providing with a driver and batteries, said driver is activated by the battery and the circuit board in such a manner to enable the rotation and vibration of the brush head of the brush jacket.

17. A phototherapeutic toothbrush as defined in claim 16, wherein said driver providing with a motor, a rotating block and an actuating rod, said brush head is internally linked to an interlocking rod, while the motor activates the brush head for rotation and vibration via the rotating block, the actuating rod and the interlocking rod.
